(19) United States
(12) Patent Application Publication
(10) Pub. No.: US 2020/0125514 A1
(43) Pub. Date: Apr. 23, 2020

(54) METHOD, DEVICE, CENTRAL DEVICE, AND SYSTEM FOR DETECTING DISTRIBUTION SHIFT IN A DATA AND/OR FEATURE DISTRIBUTION OF INPUT DATA

(71) Applicant: VOLKSWAGEN AKTIENGESELLSCHAFT, Wolfsburg (DE)

(72) Inventors: Fabian HÜGER, Wolfenbuttel (DE); Peter SCHLICHT, Wolfsburg (DE)

(73) Assignee: Volkswagen Aktiengesellschaft

(21) Appl. No.: 16/659,782

(22) Filed: Oct. 22, 2019

(30) Foreign Application Priority Data
Oct. 23, 2018 (DE) 10 2018 218 097.0

(51) Int. Cl. G06F 13/36; G06N 20/00

(52) U.S. Cl. CPC G06F 13/36; H04L 67/12; G06N 20/00

(57) ABSTRACT

A method for detecting a distribution shift in a data and/or feature distribution of input data, wherein the method is carried out in at least one mobile device and includes receiving the input data by an input device, performing a function, which is identical according to the objective, on the received input data by a first processing module and at least one second processing module, wherein the first processing module and the at least one second processing module are structurally different than one another, wherein at least the first processing module was created based on machine learning, comparing the results delivered by the processing modules and discovering a distribution shift based on the comparison result by an evaluation device, and providing a candidate signal in response to a distribution shift being discovered, and outputting the provided candidate signal by an output device.

### PRIORITY CLAIM

This patent application claims priority to German Patent Application No. 10 2018 218 097.0, filed 23 Oct. 2018, the disclosure of which is incorporated herein by reference in its entirety.

### SUMMARY

Illustrative embodiments relate to a method, an apparatus, a central device and a system for detecting a distribution shift in a data and/or feature distribution of input data.

### BRIEF DESCRIPTION OF THE DRAWINGS

Disclosed embodiments are explained in more detail below with reference to the figures, in which:

FIG. 1 shows a schematic depiction of an embodiment of the apparatus for detecting a distribution shift in a data and/or feature distribution of input data;

FIG. 2 shows a schematic depiction of an embodiment of the central device for detecting a distribution shift in a data and/or feature distribution of input data; and

FIG. 3 shows a schematic depiction of an embodiment of the system for detecting a distribution shift in a data and/or feature distribution of input data.

### DETAILED DESCRIPTION

Modern transportation vehicles are increasingly using solutions for which individual functions were produced on the basis of machine learning. Such functions relate, for example, to infotainment, driver assistance systems, safety functions, or else comfort functions and automated driving. These solutions are increasingly using deep learning approaches, for which higher-quality data, for example, as an environmental or driver model or in regard to discerned objects or to transportation vehicle control, etc., are generated from captured sensor data (ambient sensor system, interior monitoring, sensors in the transportation vehicle, etc.).

The cited functions are developed by training neural networks, wherein a neural network learns an association between higher-quality data and corresponding sensor data. Such a learning process is highly dependent on a data and/or feature distribution, that is to say on a combination of the volume of training data and the distribution of features that the volume contains, the correlation of the features with the higher-quality data being sensed by the neural network. Therefore, training strategies and training data records are chosen that portray the actually existing distribution as well as possible.

During the subsequent application of the functions taught in this manner, these distributions can change, however, e.g., on the basis of a change of behavior, ageing or new contexts (weather, season, road user, traffic regulations, etc.). Such a, generally slowly occurring, distribution shift (“concept drift”) potentially causes a gradual worsening of the functional quality of the applicable function. In this case, rating the functional quality during application of the function is extremely difficult because, in many situations, complete failure of functions, for example, on the basis of a functional limitation or a reduction in comfort, is not worthwhile. Furthermore, a distribution shift or a slight inaccuracy in the function can be discovered only with difficulty during application of the function, since a basic truth portraying the real situation is missing.

Although solutions exist for detecting distribution shifts based on autoencoders and discriminative networks, the problem is solved only unsatisfactorily at present.

The disclosed embodiments provide a method, an apparatus, a central device and a system for detecting a distribution shift in a data and/or feature distribution of input data that allow a distribution shift to be discovered in an improved manner.

A first disclosed embodiment involves a method for detecting a distribution shift in a data and/or feature distribution of input data being made available, wherein the method is carried out in at least one mobile device, comprising the following operations: receiving the input data by an input device, performing a function, which is identical according to the objective, on the received input data by a first processing module and at least one second processing module, wherein the first processing module and the at least one second processing module are structurally different than one another, wherein at least the first processing module was created on the basis of machine learning, comparing the results delivered by the processing modules and discovering a distribution shift on the basis of the comparison result by an evaluation device, and, if a distribution shift was discovered: providing a candidate signal, and outputting the provided candidate signal by an output device.

A second disclosed embodiment involves an apparatus for detecting a distribution shift in a data and/or feature distribution of input data for a mobile device being provided, comprising: an input device, wherein the input device is designed to receive the input data; a first processing module and at least one second processing module, wherein the first processing module and the at least one second processing module are structurally different than one another, wherein at least the first processing module is created on the basis of machine learning, and wherein the processing modules are designed to perform a function, which is identical according to the objective, on the received input data; an evaluation device, wherein the evaluation device is designed to compare the results delivered by the processing modules and to discover a distribution shift on the basis of the comparison result, and, if a distribution shift was discovered, to provide a candidate signal; and an output device, wherein the output device is designed to output the provided candidate signal.

A third disclosed embodiment involves a central device for detecting a distribution shift in a data and/or feature distribution of input data being provided, comprising: a reception device, wherein the reception device is designed to receive output candidate signals from at least one mobile device; an assessor device, wherein the assessor device is designed to evaluate the received candidate signals of the at least one mobile device and to discover a cumulated distribution shift and to generate a discovery signal if there is an accumulation of candidate signals of an identical type. An accumulation of candidate signals of identical type is intended in this context to mean that distribution shifts has occurred under the same circumstances or in the same context situations. Further, the central device comprises an output device, wherein the output device is designed to output the generated discovery signal.

Further, a fourth disclosed embodiment involves a system for detecting a distribution shift in a data and/or feature distribution of an input data being provided, comprising at least one apparatus in accordance with the second disclosed embodiment and a central device in accordance with the third disclosed embodiment.

It is a fundamental concept of the disclosure to have the same function performed on input data by a first processing module and at least one second processing module. In this case, the first processing module and the at least one second processing module are structurally different than one another, that is to say that although the processing modules provide functions that are identical according to an objective, for example, a function for detecting objects in captured environment data, the processing modules provide these functions in different manners. At least the first processing module was created on the basis of machine learning in this case. The at least one second processing module can likewise have been created on the basis of machine learning, but it can also have been produced and configured in another manner, for example, by a firmly prescribed (not taught) method. The results delivered by the processing modules are compared with one another and a distribution shift is discovered on the basis of the comparison result. If the function is a discernment function for object classification, for example, then a distribution shift can be discovered if the results for the object classes accordingly associated with the same object are different than one another, for example, if the associated likelihoods of the object belonging to the individual object classes exhibit differences that lie above a prescribed tolerance threshold. If a distribution shift was discovered, then a candidate signal is provided. The provided candidate signal is then output and can be processed further in accordance with the third disclosed embodiment.

By using at least two processing modules that perform the identical function according to the objective, it is possible for potential candidates for a distribution shift to be identified in a simple manner.

There can be provision for the mobile device to be a transportation vehicle. The transportation vehicle then comprises an apparatus in accordance with the second disclosed embodiment. The input data are then sensor data describing an environment and, e.g., an interior of the transportation vehicle. However, there can also be provision for a mobile device to be another land vehicle, aircraft or watercraft. There can also be provision for a mobile device to be a cellphone or an infrastructure monitoring entity (traffic camera; networked traffic control installation, e.g., traffic lights, points, sluice controller).

In at least one disclosed embodiment there is provision for the candidate signal to comprise a description of the processing modules used and/or a description of the comparison result and/or a description of a context situation. The description of the processing modules used comprises, for example, information pertaining to a structure of the processing modules. If neural networks are involved, for example, then the description can comprise information pertaining to the structure and pertaining to parameters or the individual weightings within the neural networks. Further, the description can also comprise identification numbers of the processing modules that uniquely identify the latter. A description of the comparison result comprises, for example, a qualitative and/or quantitative information pertaining to a difference that exists in the results delivered by the processing modules. A context situation comprises information describing a situation in which the distribution shift was discovered. This information can comprise, for example, location information, time information and/or other information describing the circumstances.

In at least one disclosed embodiment, there is provision for, in the event of a distribution shift being discovered, a control device of the mobile device to be used to collect additional data about a context situation in which the distribution shift has occurred. This allows further information to be selectively collected to be able to describe the context situation in an improved manner and to be able to rate and validate the discovered distribution shift in an improved manner.

In at least one disclosed embodiment, there is provision for the outputting of the candidate signal to comprise transmitting the candidate signal from the at least one mobile device to a central device in accordance with the third disclosed embodiment via an air interface. The air interface can be a mobile radio interface, for example, by which the mobile device can be wirelessly connected to the central device via the mobile radio network and/or the Internet. In principle, however, it is also possible for other wireless interfaces to be used.

In at least one disclosed embodiment, there is provision for output candidate signals of the at least one mobile device to be received by the central device by a reception device, wherein received candidate signals of the at least one mobile device are evaluated by an assessor device of the central device, and wherein a cumulated distribution shift is discovered and a discovery signal is generated and output if an accumulation of candidate signals of an identical type is discovered. By taking into consideration multiple candidate signals, it is possible to discover in an improved manner whether or not there is a distribution shift. By using further information pertaining to the individual context situations, an accumulation of candidate signals of identical type can be discovered. In this case, the type denotes a property of the distribution shift and/or of the applicable processing modules and/or of the context situation. The type can be defined be a location, a time and/or a specific class of objects and/or a specific class of comparison results and/or a specific processing module, for example. If candidate signals that can be associated with the same location increasingly occur, for example, then a distribution shift can be inferred. As such, e.g., for a location at a junction where a traffic light system could usually always be found, but at present roadworks can be found, the mobile devices, in particular, multiple transportation vehicles, can be used to generate appropriate candidate signals and to transmit them to the central device. The central device then discovers an accumulation for this location and, as a result, discovers a cumulated distribution shift, that is to say a distribution shift that was discovered at least more than once by a mobile device or by multiple mobile devices. If a cumulated distribution shift of this kind was discovered, then the discovery signal is generated. On the basis of the discovery signal, it is then subsequently possible for the first processing module, for example, to be trained to adapt to the changed distribution.

There can be provision for the candidate signals to be received by the central device by the air interface.

In at least one disclosed embodiment, there is provision for the assessor device to rate a discovered cumulated distribution shift and for the discovery signal to comprise rating information derived from the rating. The rating can comprise, for example, a strength for the distribution shift and/or a contextual categorization, i.e., information about the circumstances under which the distribution shifts have occurred. This rating information provides valuable information allowing the affected processing module(s) to be adapted to the changed distribution in an improved manner. Training data required for adaptation can be limited in terms of their representation and their volume.

In at least one disclosed embodiment, there is provision for discovery of the cumulated distribution shift to be followed by the assessor device prompting at least one further instance of the mobile devices to detect a distribution shift. This can be effected, for example, by transmitting an applicable command to the at least one further instance of the mobile devices via the air interface. The at least one further mobile device can then likewise perform the described method, for example, at the location at which the distribution shift was discovered, and, as a result, check whether a distribution shift can be discovered again. As a result, it is possible to specifically check whether there is a distribution shift or whether a measurement error or a mistake during discovery is possibly involved.

In a further disclosed embodiment, there is provision for the method operations to be alternatively or additionally repeated using at least one further second processing module. This allows second processing modules to be added selectively. If there are, for example, four processing modules in the mobile device for performing the same function, but only two of these processing modules are ever used at the same time, e.g., for reasons of energy efficiency, then different combinations of two of these processing modules can be operated at the same time in succession in each case (in each case the first processing module with in each case one of the three other second processing modules), the method being carried out progressively for each combination in each case. There can then be the stipulation that a distribution shift is discovered, and a candidate signal is generated, only if such a distribution shift is discovered in all three combinations. In the case of a transportation vehicle as the mobile device, the individual combinations can be used for successive journeys by the transportation vehicle along the same stretch, for example, the method being repeated for each of the combinations for a new journey on the stretch.

In a further disclosed embodiment, there is provision for the input data to be recorded by a memory device of the mobile device before being received and to be transmitted to the input device only after the recording. In this manner, a computing power required for detecting a distribution shift can be dispensed with during a journey by a mobile device, such as a transportation vehicle, for example. Input data received from sensors are stored in the memory device and are processed by the processing modules only following conclusion of the journey, and examined for a distribution shift by the evaluation device. This is effected, for example, when the transportation vehicle parks and is otherwise not used (or more generally when the mobile unit does not have to perform its actual function or has free computing capacities at its disposal elsewhere—this can also be effected by the computing operations being relocated via an (air) interface—examples of this are the connection of the mobile unit to a charging infrastructure). If a distribution shift is discovered, then the applicable data are transmitted to the central device. As a result, a computing power can be distributed to functions required for the journey and to the detection of a distribution shift with optimum timing. This allows a maximum reserved computing power that is present in the transportation vehicle to be reduced, as a result of which it is possible for an energy consumption and costs to be reduced.

Parts of the apparatus and of the central device, individually or in combination, can be a combination of hardware and software, for example, as program code executed on a microcontroller or microprocessor.

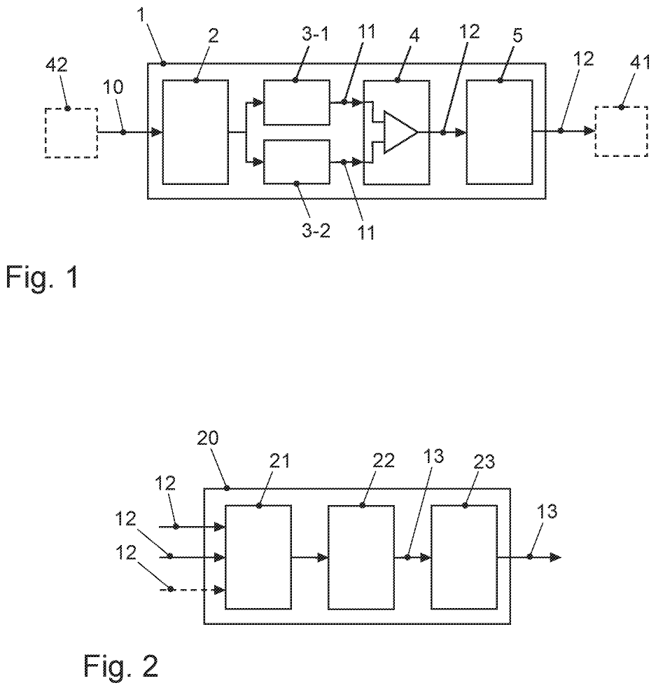

FIG. 1 shows a schematic depiction of a disclosed embodiment of the apparatus 1 for detecting a distribution shift in a data and/or feature distribution of input data 10. The apparatus 1 is used in a mobile device. The apparatus 1 comprises an input device 2, a first processing module 3-1, a second processing module 3-2, an evaluation device 4 and an output device 5. The input device 2 receives the input data 10. The input data 10 are, for example, sensor data captured by sensors of a mobile device, the sensor data being provided to the apparatus 1.

The input data 10 are supplied to the processing modules 3-1, 3-2 by the input device 2. The first processing module 3-1 and the second processing module 3-2 are structurally different than one another. At least the first processing module 3-1 was created on the basis of machine learning and comprises a neural network. The second processing module 3-2 can likewise comprise a neural network, but can also have been produced in a different manner. Both processing modules 3-1, 3-2 perform a function that is identical according to the objective on the received input data 10, for example, a discernment function classifying objects in the environment of the mobile device.

The results 11 delivered by the processing modules 3-1, 3-2 are supplied to the evaluation device 4. The evaluation device 4 compares the results 11 with one another and provides a candidate signal 12 if a distribution shift was discovered. By way of example, such a distribution shift can be discovered if the processing modules 3-1, 3-2 deliver different classifications of objects as results 11. The object classes associated with the individual objects to be classified as class likelihoods are compared with one another in this case. There can also be provision in this case for prescribed thresholds, for example, for a number of differently classified objects, so that a distribution shift is discovered.

The output device 5 subsequently outputs the provided candidate signal 12. The outputting can be effected as a digital data packet, for example. The candidate signal 12 can be transmitted to a central device by an air interface, for example, by a mobile radio interface.

There can be provision for the candidate signal 12 to comprise a description of the processing modules 3-1, 3-2 used and/or a description of the comparison result and/or a description of a context situation in which the distribution shift was discovered.

There can further be provision for, in the event of a distribution shift being discovered, a control device 41 of the mobile device 40 to be used to collect additional data about a context situation in which the distribution shift has occurred. These additional data can likewise be transmitted with the candidate signal 12.

There can further be provision for the input data 10 to be recorded by a memory device 42 of the mobile device (or alternatively of the apparatus 1 not shown) 40 before being received and to be transmitted to the input device 2 only after the recording. This allows a computing complexity to be distributed with better timing or a maximum available computing power to be reduced.

FIG. 2 shows a schematic depiction of a disclosed embodiment of the central device 20 for detecting a distribution shift in a data and/or feature distribution of input data. The central device 20 is situated outside the mobile devices and is produced in a central server, for example.

The central device 20 comprises a reception device 21, an assessor device 22 and an output device 23.

The reception device 21 receives output candidate signals 12 (c.f. also FIG. 1) from at least one mobile device. In this case, there can be provision for the reception device 21 to receive multiple candidate signals 12 from one mobile device, for example, candidate signals 12 that were generated and provided at different times. However, there can also be provision for candidate signals 12 to be received from different mobile devices, for example, from multiple transportation vehicles, that discover a distribution shift in the respective input data in the same context situation and each provide a candidate signal 12. The receiving of the candidate signals 12 can be effected as a digital data packet, for example.

The assessor device 22 evaluates the received candidate signals 12 of the one or more mobile device(s) and discovers a cumulated distribution shift if there is an accumulation of candidate signals 12 of an identical type. In this case, the type denotes a context in which the individual distribution shifts have occurred, for example, location information, time information or specific classes of features, for example, object classes. If a cumulated distribution shift is discovered by the assessor device 22, then the latter generates a discovery signal 13.

The output device 23 outputs the generated discovery signal 13. This can be effected as a digital data packet, for example. The discovery signal 13 can comprise not only the information that there is a cumulated distribution shift, that is to say a distribution shift discovered by multiple mobile devices, but also further information pertaining to the context in which the cumulated distribution shift or the individual distribution shifts were discovered. This further information is then likewise output.

On the basis of the output discovery signal 13, it is then possible for measures to be taken to train the first processing module 3-1 to the changed distribution in the input data 10. However, there can be provision for the second processing module 3-2 also to be adapted.

There can be provision for the assessor device 22 to rate a discovered cumulated distribution shift and for the discovery signal 13 to comprise rating information derived from the rating.

Further, there can be provision for discovery of the cumulated distribution shift to be followed by the assessor device 22 prompting at least one further instance of the mobile devices to detect a distribution shift. To this end, the central device 20 generates, for example, an applicable command signal and transmits it to the at least one further mobile device, so that the latter likewise performs the method for detecting a distribution shift in the applicable context.

There can be provision for the method operations to be alternatively or additionally repeated using at least one further second processing module 3-2 (cf. FIG. 1). This allows, for example, processing modules 3-1, 3-2 that are deactivated during normal operation to be selectively activated to be able to trace distribution shifts in an improved manner. This also allows, for example, specific stipulations regarding a minimum number of processing modules 3-1, 3-2 that need to be involved in the discovery of the distribution shift to be taken into consideration. By way of example, there can be provision for the results from four processing modules 3-1, 3-2 to need to be compared with one another so that a distribution shift can be discovered. If, however, only two of the four processing modules 3-1, 3-2 are ever active during normal operation, then the method can be performed at later times, in each case with different combinations of in each case the first processing module 3-1 with in each case one of the three second processing modules 3-2.

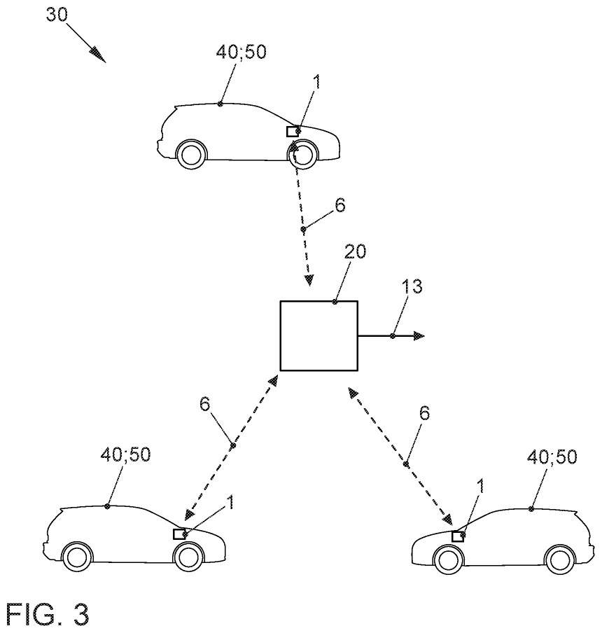

FIG. 3 shows a schematic depiction of a disclosed embodiment of the system 30 for detecting a distribution shift in a data and/or feature distribution of input data. The system 30 comprises multiple instances of the apparatuses 1, which are each arranged in mobile devices 40 as transportation vehicles 50, and a central device 20. Following the respective discovery of a distribution shift, the apparatuses 1 transmit the respective candidate signal via air interfaces 6 to the central device 20, which generates and outputs a discovery signal 13 depending on the accumulation.

There can likewise be provision for the assessor device of the central device 20 to prompt mobile devices 40 or the apparatuses 1 in the transportation vehicles 50 to follow discovery of a cumulated distribution shift by detecting distribution shifts and capturing measurement data corresponding thereto. The system 30 can therefore be used to use a fleet of transportation vehicles 50 to specifically trace and examine distribution shifts. The detection of a distribution shift is distinctly improved thereby, since detection is effected continually and always on the basis of current input data.

Parts of the apparatus 1 and of the central device 20, individually or in combination, can be a combination of hardware and software, for example, as program code executed on a microcontroller or microprocessor.

### LIST OF REFERENCE SIGNS

1 Apparatus
2 Input device
3-1 Processing module
3-2 Processing module
4 Evaluation device
5 Output device
6 Air interface
10 Input data
11 Result
12 Candidate signal
13 Discovery signal
20 Central device
21 Reception device
22 Assessor device
23 Output device
30 System
40 Mobile device
41 Control device
42 Memory device
50 Transportation vehicle

1. An apparatus for detecting a distribution shift in a data and/or feature distribution of input data for a mobile device, the apparatus comprising:
an input device, wherein the input device receives the input data;
a first processing module and at least one second processing module, wherein the first processing module and the at least one second processing module are structurally different than one another, wherein at least the first processing module is created based on machine learning, and wherein the processing modules perform a function, which is identical according to the objective, on the received input data;
an evaluation device, wherein the evaluation device compares the results delivered by the processing modules and discovers a distribution shift based on the comparison result, and provides a candidate signal in response to a distribution shift being discovered, and
an output device, wherein the output device outputs the provided candidate signal.

2. The apparatus of claim 1, wherein the output device comprises an air interface, wherein the air interface transmits the candidate signal to a central device.

3. A central device for detecting a distribution shift in a data and/or feature distribution of input data, the central device comprising:
a reception device, wherein the reception device receives output candidate signals from at least one mobile device;
an assessor device, wherein the assessor device evaluates the received candidate signals of the at least one mobile device and discovers a cumulated distribution shift and generates a discovery signal in response to there being an accumulation of candidate signals of an identical type, and
an output device, wherein the output device outputs the generated discovery signal.

4. The central device of claim 3, wherein the assessor device follows discovery of the cumulated distribution shift by prompting at least one further instance of the mobile devices to detect a distribution shift.

5. A system for detecting a distribution shift in a data and/or feature distribution of input data, the system comprising:
at least one apparatus according to claim 1, and
a central device for detecting the distribution shift in the data and/or feature distribution of input data, wherein the central device includes a reception device, wherein the reception device receives output candidate signals from at least one mobile device, an assessor device, wherein the assessor device evaluates the received candidate signals of the at least one mobile device and discovers a cumulated distribution shift and generates a discovery signal in response to there being an accumulation of candidate signals of an identical type, and an output device, wherein the output device outputs the generated discovery signal.

6. A method for detecting a distribution shift in a data and/or feature distribution of input data, wherein the method is carried out in at least one mobile device, the method comprising:
receiving the input data by an input device;
performing a function, which is identical according to the objective, on the received input data by a first processing module and at least one second processing module, wherein the first processing module and the at least one second processing module are structurally different than one another, wherein at least the first processing module was created based on machine learning;
comparing the results delivered by the processing modules and discovering a distribution shift based on the comparison result by an evaluation device, and providing a candidate signal in response to the distribution shift being discovered; and
outputting the provided candidate signal by an output device.

7. The method of claim 6, wherein the candidate signal comprises a description of the processing modules used and/or a description of the comparison result and/or a description of a context situation.

8. The method of claim 6, wherein a control device of the mobile device is used to collect additional data about a context situation in which the distribution shift has occurred in response to a distribution shift being discovered.

9. The method of claim 6, wherein the outputting of the candidate signal comprises transmitting the candidate signal from the at least one mobile device to a central device via an air interface.

10. The method of claim 6, wherein output candidate signals of the at least one mobile device are received by the central device by a reception device, wherein received candidate signals of the at least one mobile device are evaluated by an assessor device of the central device, and wherein a cumulated distribution shift is discovered and a discovery signal is generated and output in response to an accumulation of candidate signals of an identical type being discovered.

11. The method of claim 10, wherein the assessor device rates a discovered cumulated distribution shift and the discovery signal comprises rating information derived from the rating.

12. The method of claim 10, wherein discovery of the cumulated distribution shift is followed by the assessor device prompting at least one further instance of the mobile devices to detect a distribution shift.

13. The method of claim 6, wherein the method operations are alternatively or additionally repeated using at least one further second processing module.

14. The method of claim 6, wherein the input data are recorded by a memory device of the mobile device before being received and are transmitted to the input device only after the recording.
